(19) United States
(12) Patent Application Publication
(10) Pub. No.: US 2010/0046917 A1
(43) Pub. Date: Feb. 25, 2010

(54) 3D ENABLED PLAYER/RECORDER

(76) Inventor: David Naranjo, Chula Vista, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/539,457

(22) Filed: Aug. 11, 2009

Related U.S. Application Data
(60) Provisional application No. 61/090,649, filed on Aug. 21, 2008.

(51) Int. Cl. H04N 5/91; H04N 13/00

(52) U.S. Cl. 386/95; 348/42; 348/E13.001; 386/E05.001

(57) ABSTRACT

Systems and methods that facilitate the playback of 3D content on 3D ready or capable televisions. In a preferred embodiment, a content player when instructed to playback video content will auto detect and transmit the 3D content to a 3D ready television and also control the television via CEC to “place” the television in 3D mode.

### CROSS-REFERENCE TO RELATED APPLICATION

This application claims the benefit of provisional application Ser. No. 61/090,649 filed Aug. 21, 2008, which is fully incorporated herein by reference.

### FIELD

The present invention relates generally to televisions and, more particularly, to three dimensional (3D) enabled player/recorder.

### BACKGROUND

Three dimensional (3D) cinema continues to expand with more and more titles being released on a regular basis. Up to 20 or more titles are expected to be released in the coming year. Hollywood had announced significant resources for the creation and distribution of 3D cinema content. While no existing devices for the home can playback this content, television manufacturers have begun developing and manufacturing 3D ready televisions. Thus it would be desirable to have playback devices for the home that are capable of playing back 3D content to 3D ready televisions.

### SUMMARY

Embodiments described herein are directed to systems and methods that facilitate the playback of 3D content on 3D ready or capable televisions. In a preferred embodiment, a content player when instructed to playback video content will auto detect and transmit the 3D content to a 3D ready television and also control the television via Consumer Electronic Control (CEC) protocol to “place” the television in 3D mode.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television system.

FIG. 2 is a flow chart schematic showing system operation.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Embodiments described herein are directed to improved methods and systems for playback of 3D content on a television. In a preferred embodiment, a content player when instructed to playback video content will auto detect and transmit the 3D content to a 3D ready television and also control the television via CEC to “place” the television in 3D mode. As provided herein, the embodiments utilize the device auto detect mechanisms incorporated in High Definition Multimedia Interface (HDMI) 1.3 (CEC) and IEEE 1394 compliant televisions, content playback devices such as DVD players, Blu-ray players and other audio-video components to detect their connection to another device and the connected device to supply its control features.

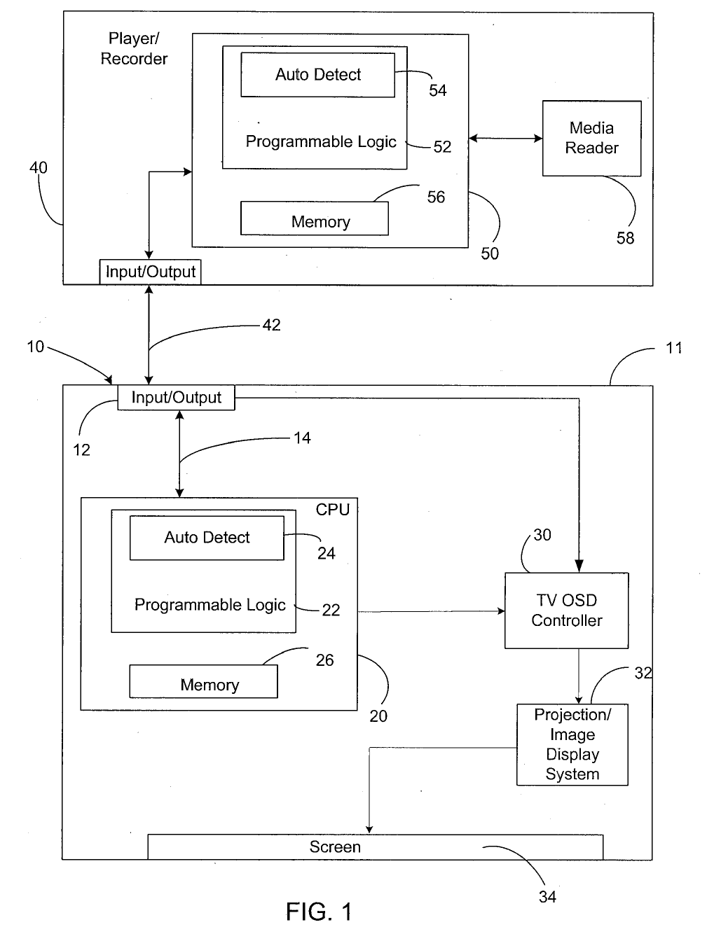

Turning to the figures, the embodiments provided herein are described in detail. A television 10, as depicted in FIG. 1, includes an enclosure 11 and a screen 34 housed in or coupled to the enclosure 11. Housed within the enclosure 11 is a central processing unit (CPU) 20 including non-volatile memory 26 and programmable logic 24, which can be in the form of system software stored in memory, integrated circuits, application specific integrated circuit chips and the like. The software preferably comprises a set of instructions to enable the setup and operation of the television 10. The programmable logic 22 preferably includes an auto detect module 24.

Also housed within the enclosure 11 is an image display system 32, such as a projection system or the like, coupled to the screen 34, and an on screen display (OSD) controller 30 coupled to the CPU 20 and the image display system 32. The OSD 30 controls what is displayed on the screen 34. The television 10 also preferably includes one or more input/output ports 12 such as an HDMI port, 1394 ports and the like coupled to OSD controller 30. The input/output ports 12 are preferably coupled to the CPU 20 over a bidirectional bus 14 to allow the control commands in HDMI(CEC) and 1394 form to flow to and from a connected device.

A player or player/recorder device 40 such as an HDMI and/or 1394 compliant DVD player, Blu-ray player or the like, which is capable of transmitting and receiving data over a bi-directional bus is coupled over a bi-directional cable 42 or wirelessly to the television 10 to transmit video content and control commands to the television 10. The player device 40 includes a CPU 50 including non-volatile memory 52 and programmable logic 54, which can be in the form of system software stored in memory, integrated circuits, application specific integrated circuit chips and the like, and a media reader 58 coupled to the CPU 50. The software preferably comprises a set of instructions to enable the setup and operation of the player device 40. The programmable logic 52 preferably includes an auto detect module 54. Once connected to the television 10, the device 40 auto-detects the television 10 and prompts the television 10 to transmit its control features to the player device 40.

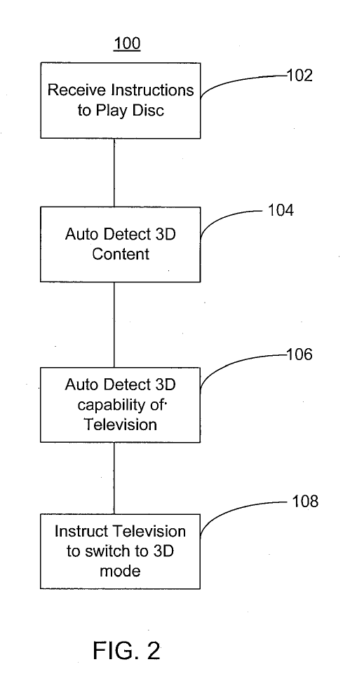

In operation, as shown in FIG. 2, the process 100 of playing back content stored on a storage medium such as a disc comprises first receiving instructions 102 to playback the content stored on the storage medium. The instruction can be received from a control panel on the front panel of the player device 40 or from an IR or RF base remote control unit. Once the player device 40 receives the instruction to playback the video content on the storage medium, the player device 40 auto-detects 104 whether or not the content to be played back is 3D video content. If the content to be played back is 3D video content, the player device auto-detects 106 whether the television 10 is 3D ready or capable of displaying 3D video content.

If the television 10 is 3D ready or capable of displaying 3D video content, the player device 40 causes 108 the television to switch to 3D video display mode and display the video content being transmitted from the player device and perform the necessary switching to output the audio over the system's loud speakers. If the television 10 is not 3D ready, the player device 40 will display an error message and instruct the television 10 to display the error message.

The particular examples set forth herein are instructional and should not be interpreted as limitations on the applications to which those of ordinary skill are able to apply this device. Modifications and other uses are available to those skilled in the art which are encompassed within the spirit of the invention as defined by the scope of the following claims.

What is claimed is:

1. A method of controlling playback of 3D video content from a 3D media player on a display unit comprising the steps of
receiving instructions to playback video content contained on content medium for display on a display unit,
determining whether video content contained on the medium is 3D video content,
determining whether a display unit to which the video content is to be displayed is capable of displaying 3D video content,
sending instructions to the display unit to cause the display unit to switch to 3D video display mode, and
transmitting the 3D video content to the display unit for display.

2. A method of controlling playback of 3D video content from a 3D media player on a display unit comprising the steps of
receiving instructions to playback video content stored on storage medium for display on a display unit,
determining whether video content stored on the storage medium is 3D video content,
determining whether a display unit to which the video content is to be displayed is capable of displaying 3D video content,
sending instructions to the display unit to cause the display unit to switch to 3D video display mode if the display unit is capable of displaying 3D video content or to display an error message if the display unit is incapable of displaying 3D video content, and
transmitting the 3D video content to the display unit for display if the display unit is capable of displaying 3D video content.

3. A 3D media player comprising
a CPU including non-volatile memory and programmable logic, wherein the CPU is capable of transmitting and receiving data over a bi-directional, and
a media reader coupled to the CPU, wherein the programmable logic is configured to determine whether video content stored on a storage medium read by the media reader contains 3D video content, to determine whether a display unit to which the video content is to be displayed is capable of displaying 3D video content, to transmit instructions to cause a display unit to which the video content is to be displayed to switch to a 3D video display mode if the display unit is capable of displaying 3D video content or to display an error message if the display unit is incapable of displaying 3D video content, and to transmit 3D video content to a display unit to which the video content is to be displayed if the display unit is capable of displaying 3D video content.

4. The 3D media player of claim 3 wherein the programmable logic includes software stored in the non-volatile memory, wherein the software comprises a set of instructions.

5. The 3D media player of claim 3 wherein the programmable logic includes an auto detect module.

6. A 3D media display system comprising
a television, and
a 3D media player coupled to the television, wherein the 3D media player includes
a CPU including non-volatile memory and programmable logic, wherein the CPU is capable of transmitting and receiving data over a bi-directional, and
a media reader coupled to the CPU, wherein the programmable logic is configured to determine whether video content stored on a storage medium read by the media reader contains 3D video content, to determine whether a display unit to which the video content is to be displayed is capable of displaying 3D video content, to transmit instructions to cause a display unit to which the video content is to be displayed to switch to a 3D video display mode if the display unit is capable of displaying 3D video content or to display an error message if the display unit is incapable of displaying 3D video content, and to transmit 3D video content to a display unit to which the video content is to be displayed if the display unit is capable of displaying 3D video content.

7. The 3D media player of claim 6 wherein the programmable logic includes software stored in the non-volatile memory, wherein the software comprises a set of instructions.

8. The 3D media player of claim 6 wherein the programmable logic includes an auto detect module.
